(19) United States
(12) Patent Application Publication
(10) Pub. No.: US 2015/0151236 A1
(43) Pub. Date: Jun. 4, 2015

(54) FILTER MEDIA AND METHOD OF FORMING THEREOF

(71) Applicant: BHA Altair, LLC, Franklin, TN (US)

(72) Inventors: Vishal Bansal, Overland Park, KS (US); Ryan Margate Pastrana, Kansas City, MO (US); Martin Gregory Hatfield, Odessa, MO (US); Robert Warren Taylor, Ponte Vedra Beach, FL (US); Todd Joseph Scheerer, Lee's Summit, MO (US)

(73) Assignee: BHA Altair, LLC, Franklin, TN (US)

(21) Appl. No.: 14/096,714

(22) Filed: Dec. 4, 2013

(51) Int. Cl. B01D 46/54; B32B 37/18; D05B 1/02; F01N 3/021; B01D 46/00

(52) U.S. Cl. CPC B01D 46/543; F01N 3/021; B01D 46/0001; D05B 1/02; B32B 37/18; B32B 2038/008

(57) ABSTRACT

A filter media is provided. The filter media includes a porous membrane material, and at least one fiber stitched into the porous membrane material. A property of the filter media is selected as a function of a stitch configuration of the at least one fiber in the filter media.

### BACKGROUND

The field of the present disclosure relates generally to filter media and, more specifically, to high-temperature filter media having improved structural properties.

At least some known power generation systems include a furnace and/or a boiler that generates steam used in a steam turbine generator. During a typical combustion process, a flow of combustion gas or flue gas produced within a combustor, a furnace, and/or a boiler and channeled for use in the steam turbine generator. Known combustion gases contain combustion products such as, but not limited to, carbon, fly ash, carbon dioxide, carbon monoxide, water, hydrogen, nitrogen, sulfur, chlorine, arsenic, selenium, and/or mercury.

One known method of reducing combustion products in a flue gas stream includes channeling the combustion gas through a particulate collection device, such as a baghouse. At least some known baghouses include a housing that has an inlet that receives dirty, particulate-containing air, and an outlet through which clean air is discharged from the baghouse. In known baghouses, a tube sheet divides the interior of the housing into an upstream, dirty air plenum, and a downstream, clean air plenum. Air flows through the inlet into the dirty air plenum, through a plurality of filters, and into the clean air plenum before the clean air is discharged through the outlet of the housing. Known tube sheets are formed with a plurality of apertures that couple the dirty air plenum in flow communication with the clean air plenum through the filters. More specifically, each filter element is coupled about a respective aperture formed in the tube sheet such that at least a portion of the filter element extends through the aperture.

At least some known filters are fabricated by coupling a nonwoven felt material to a microporous membrane to form a composite filter media. More specifically, the nonwoven felt material may be thermally laminated to the microporous membrane material to impart strength to the microporous membrane. Such processes may be costly and laborious tasks, and may increase the basis weight of the filter media. Moreover, permeability of the filter media is substantially reduced at lamination points between the nonwoven felt material and the microporous membrane.

### BRIEF DESCRIPTION

In one aspect, a filter media is provided. The filter media includes a porous membrane material, and at least one fiber stitched into the porous membrane material. A property of the filter media is selected as a function of a stitch configuration of the at least one fiber in the filter media.

In another aspect, a filtration system is provided. The filtration system includes a filter house and a filter media positioned within the filter house. The filter house includes a porous membrane material and at least one fiber stitched into the porous membrane material, wherein a property of the filter media is selected as a function of a stitch configuration of the at least one fiber in the filter media.

In yet another aspect, a method of forming a filter media is provided. The method includes providing a porous membrane material and stitching at least one fiber into the porous membrane material, wherein a property of the filter media is selected as a function of a stitch configuration of the at least one fiber in the filter media.

### BRIEF DESCRIPTION OF THE DRAWINGS

FIG. 1 is a schematic illustration of an exemplary baghouse.

FIG. 2 is a schematic illustration of an exemplary filter element that may be used with the filtration assembly shown in FIG. 1.

FIG. 3 is a cross-sectional illustration of an alternative filter element that may be used with the filtration assembly shown in FIG. 1.

FIG. 4 is an enlarged perspective view of an exemplary filter media that may be used with the filter element shown in FIG. 2.

FIG. 5 is a cross-sectional illustration of the filter media shown in FIG. 4 including fibers stitched therein having a first stitch configuration.

FIG. 6 is a cross-sectional illustration of the filter media shown in FIG. 4 including fibers stitched therein having a second stitch configuration.

FIG. 7 is a cross-sectional illustration of the filter media shown in FIG. 4 including fibers stitched therein having a third stitch configuration.

FIG. 8 is a cross-sectional illustration of the filter media shown in FIG. 4 including fibers stitched therein having a fourth stitch configuration.

FIG. 9 is a top illustration of the filter media shown in FIG. 4 including fibers stitched therein having a fifth stitch configuration.

### DETAILED DESCRIPTION

The embodiments described herein relate to a filter media having improved mechanical properties over known alternatives. More specifically, the filter media includes a porous membrane material and at least one fiber stitched into the porous membrane material. In the exemplary embodiment, a property of the filter media may be selected as a function of a stitch configuration of the at least one fiber. For example, the fiber may have different stitch configurations at predetermined regions of the filter media, and/or the fiber may be fabricated from different materials at predetermined regions of the filter media. As such, any combination of stitch configurations and materials used to form the fibers may be selected such that the filter media has desired properties.

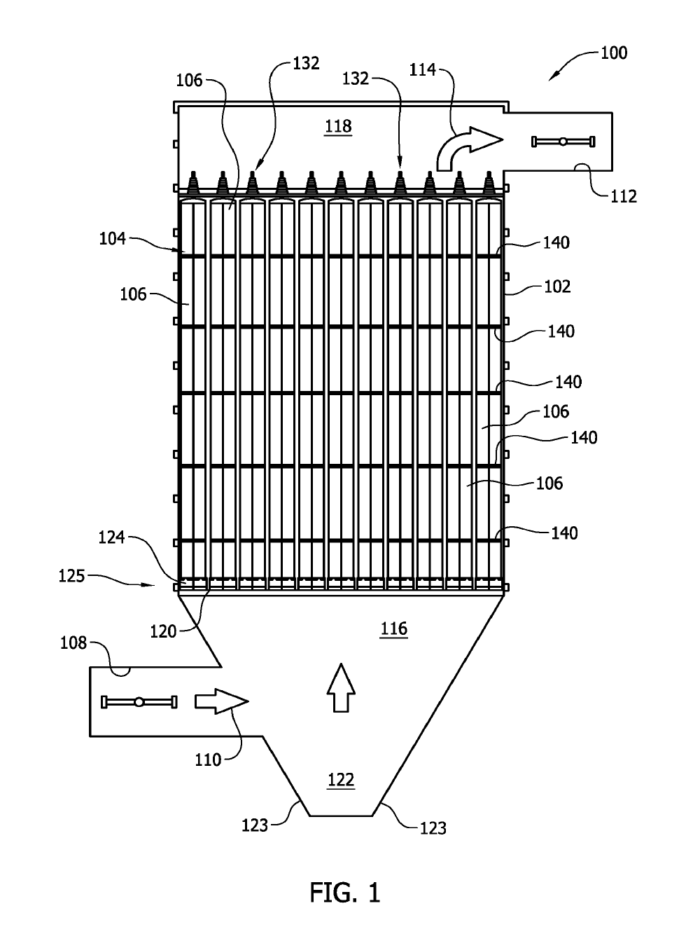

FIG. 1 is a schematic illustration of an exemplary baghouse 100. In the exemplary embodiment, baghouse 100 includes a housing 102 and a plurality of filter assemblies 104 within housing 102. Each filter assembly 104 includes a filter bag 106. Baghouse 100 also includes an inlet 108 that is oriented to receive a stream of particulate-laden gas 110 and an outlet 112 that enables a stream of cleaned gas 114 to be discharged from baghouse 100. In an alternative embodiment, baghouse 100 may be a pulse-jet baghouse.

Housing 102 is divided into a first plenum 116 and a second plenum 118 by a cell plate 120. Cell plate 120 may be fabricated from any suitable material, such as a metal plate or sheet. Inlet 108 is positioned in flow communication with first plenum 116, and outlet 112 is positioned in flow communication with second plenum 118. In the exemplary embodiment, an accumulation chamber 122 at a lower end of first plenum 116 is defined by sloped walls 123. More specifically, in the exemplary embodiment, accumulation chamber 122 has a V-shaped cross-sectional profile. In one embodiment, a baffle (not shown) is included within first plenum 116. Cellplate 120 may include thimbles (not shown) that extend from cellplate 120 for use in coupling cellplate 120 to filter bag 106. In an alternative embodiment, baghouse 100 may also include a reverse flow sub-system (not shown) to facilitate removing dust or other particulate matter from filter bag 106. The reverse flow sub-system may include a fan (not shown), wherein the size of the fan is selected based on a fixed volume of air within baghouse 100.

In the exemplary embodiment, a plurality of filter assemblies 104 are suspended from a tensioning assembly 132. More specifically, in the exemplary embodiment, each filter assembly 104 is supported at a closed end 125 of each filter bag 106 via a support structure 124. In the exemplary embodiment, each filter assembly 104 hangs from a tensioning assembly 132. Further, in the exemplary embodiment, filter bag 106 includes at least one anti-collapse ring 140 that maintains filter bag 106 in an open position during a reverse air cleaning process. Anti-collapse ring 140 may be formed from a metal material.

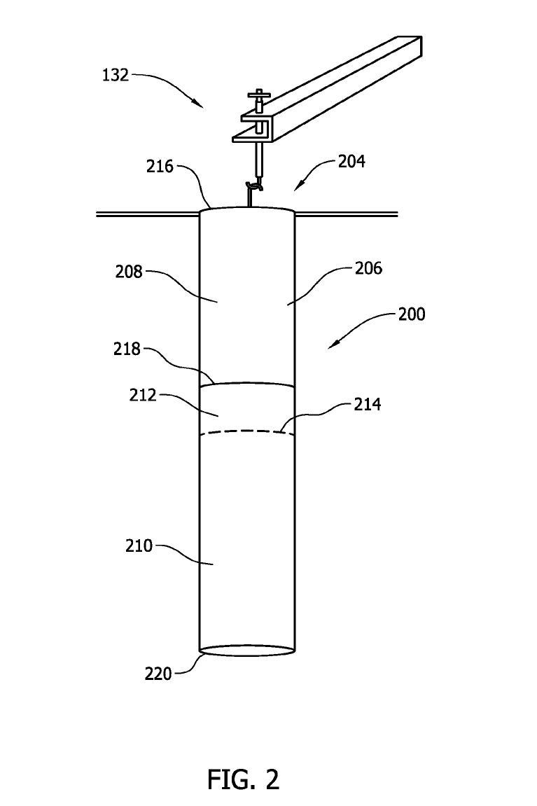

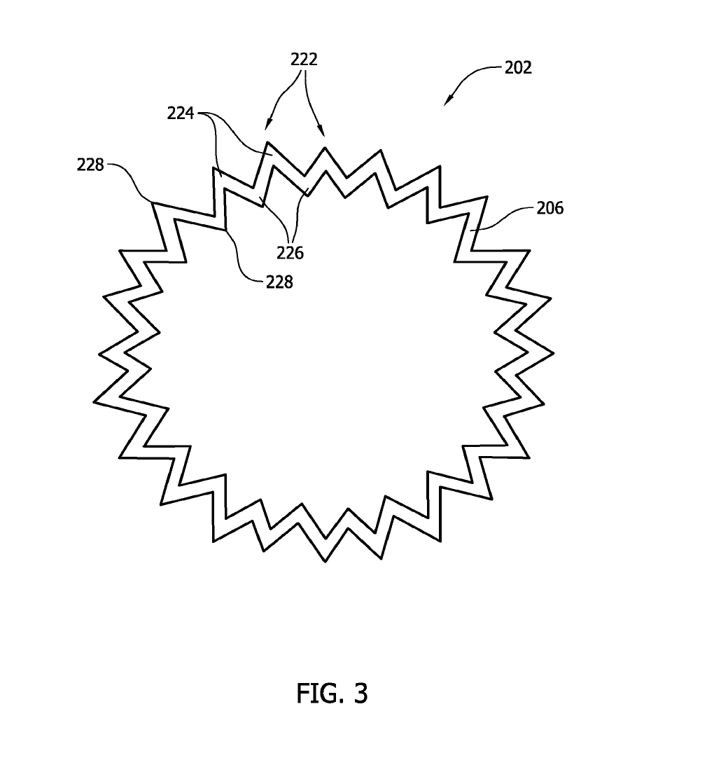

FIG. 2 is a schematic illustration of an exemplary filter element 200, and FIG. 3 is a cross-sectional illustration of an alternative filter element 202. In the exemplary embodiment, filter element 200 is a filter bag 204 formed from a filter media 206 having a substantially cylindrical cross-sectional shape. Filter bag 204 includes a first section 208, a second section 210 coupled to first section 208, and an overlapping section 212 formed when first and second sections 208 and 210 are coupled together. More specifically, first section 208 includes a first end 214 and a second end 216, and second section 210 includes a first end 218 and a second end 220. First ends 214 and 218 of first and second sections 208 and 210 crossover when forming filter element 200 such that overlapping section 212 is defined therebetween. In an alternative embodiment, filter element 200 may have any shape that enables baghouse 100 (shown in FIG. 1) to function as described herein, such as an elliptical or rectangular shape. Moreover, alternatively, filter element 200 may be any filter element that enables filter assemblies 104 to function as described herein, such as a filter cartridge.

Referring to FIG. 3, filter element 202 is formed from filter media 206 having a plurality of pleats 222 formed therein. In the exemplary embodiment, each pleat 222 includes a peak region 224 and a valley region 226 formed by a plurality of fold lines 228. Pleating filter media 206 facilitates increasing a surface area of filter element 202 to be exposed to particles entrained in fluid flow.

In the exemplary embodiment, filter media 206 generally has different filtration characteristics at predetermined regions (not shown) of filter media 206. Exemplary filtration characteristics include, but are not limited to permeability and porosity of filter media 206. For example, the filtration characteristics of filter media 206 at overlapping section 212 (shown in FIG. 2) and at peak and/or valley regions 224 and 226 may be different than at other regions of filter media 206. More specifically, the increased thickness of filter media 206 at overlapping section 212, and at peak and/or valley regions 224 and 226 facilitates modifying filtration characteristics of filter media 206.

Moreover, some predetermined regions of filter media 206 are generally subjected to greater strain than other regions of filter media 206. For example, filter media 206 is generally subjected to greater strain at second end 216 of first section 208 of filter element 200 when hung from tensioning assembly 132. More specifically, the strain induced to filter element 200 progressively decreases as filter element 200 extends from second end 216 of first section 208 towards second end 220 of second section 210. Filter media 206 is also generally subjected to greater strain at peak and valley regions 224 and 226 when filter element 202 undergoes reverse pulse cleaning operations, for example. As such, a configuration of filter media 206 may be modified to ensure that predetermined regions of filter media 206 have desired properties.

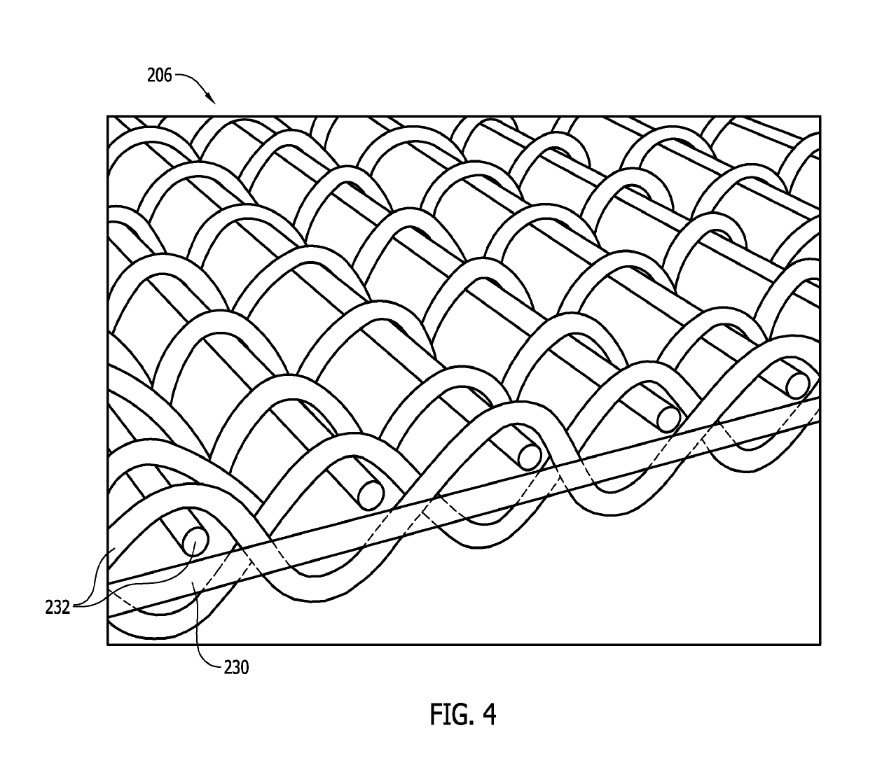

FIG. 4 is an enlarged perspective view of filter media 206. In the exemplary embodiment, filter media 206 includes a porous membrane material 230 and at least one fiber 232 stitched into porous membrane material 230. Fibers 232 are stitched into porous membrane material 230 to provide desired properties to filter media 206. Exemplary properties include, but are not limited to, overall strength of filter media 206, strength directionality of filter media 206, permeability of filter media 206, porosity of filter media 206, and an operational status of filter media 206. The properties to be provided to filter media 206 are selected as a function of a stitch configuration of fibers 232 in filter media 206.

In the exemplary embodiment, filter media 206 consists essentially of porous membrane material 230 and fibers 232 stitched into porous membrane material 230. More specifically, stitching fibers 232 into porous membrane material 230 enables filter media 206 to be formed without coupling a nonwoven felt material (not shown) to porous membrane material 230. As such, filter media 206 generally has a lower basis weight than known composite filter media that include nonwoven felt material. In the exemplary embodiment, filter media 206 has a basis weight of between about 8 ounces per square yard and about 10 ounces per square yard. In an alternative embodiment, an additional layer of porous membrane material may be laminated to filter media 206.

Porous membrane material 230 may be fabricated from any material that enables filter media 206 to function as described herein. Exemplary porous membrane materials include, but are not limited to, polytetrafluoroethylene, polyvinylidene fluoride, polyalkene, polyarylene, polyamide, polyester, polysulfone, polyether, polyacrylic, polystyrene, polyurethane, polyarylate, polyimide, polycarbonate, polysiloxane, polyphenylene oxide, cellulosic polymer, or substituted derivatives thereof.

Fibers 232 may be fabricated from any material that enables filter media 206 to function as described herein. Exemplary fiber materials include, but are not limited to, a polypropylene material, a polyester material, a polyphenylene sulfide material, a polytetrafluoroethylene material, a nylon material, an aramid material, a polyarylene sulfide material, a polyimide material, a polyamide material, a polyetherimide material, and a polyamideimide material. Moreover, a plurality of fibers 232 may be stitched into porous membrane material 230 and each fiber 232 may be fabricated from different materials.

In some embodiments, fibers 232 are fabricated from materials having hydrophilic and/or oleophobic properties. For example, stitching fibers 232 having hydrophilic properties into porous membrane material 230 facilitates imparting hydrophilic properties to filter media 206. As such, hydrophilic fibers facilitate “wicking” liquid out of pores (not shown) defined in porous membrane material 230, and facilitate reducing a pressure drop across filter media 206. Fibers 232 may also be fabricated from a conductive material that facilitates providing electric charge dissipation capabilities to filter media 206. More specifically, an electric field may be applied to filter media 206 to electrically charge fibers 232. As such, providing fibers 232 with an electric charge facilitates improving the particle removal efficiency of filter media 206.

Fibers 232 may also be fabricated from material having sorbent capabilities. For example, in operation, the sorbent material will selectively target gas phase constituents of fluid to be filtered by filter media 206 that will facilitate degrading components of a turbine engine (not shown). When filter media 206 includes fibers 232 formed from conductive material and sorbent material, supplying an electric charge to filter media 206 may be used to regenerate the sorbent material. Moreover, heating sorbent material using a Joule effect will facilitate regenerating filter media 206 by forcing the adsorbed gas to the ambient environment.

In one embodiment, some fibers 232 are fabricated from a taggant material. As used herein, “taggant” refers to a material configured to be reactive with fluid channeled through filter media 206. For example, the taggant material may respond to temperature and/or particle build-up on filter media 206. In some embodiments, the response is in the form of a color change of the taggant material. As such, the taggant material enables fibers 232 fabricated therefrom to provide an operational status of filter media 206. For example, a color change of the taggant material may indicate that filter element 200 or 202 (shown in FIGS. 2 and 3) needs to be replaced.

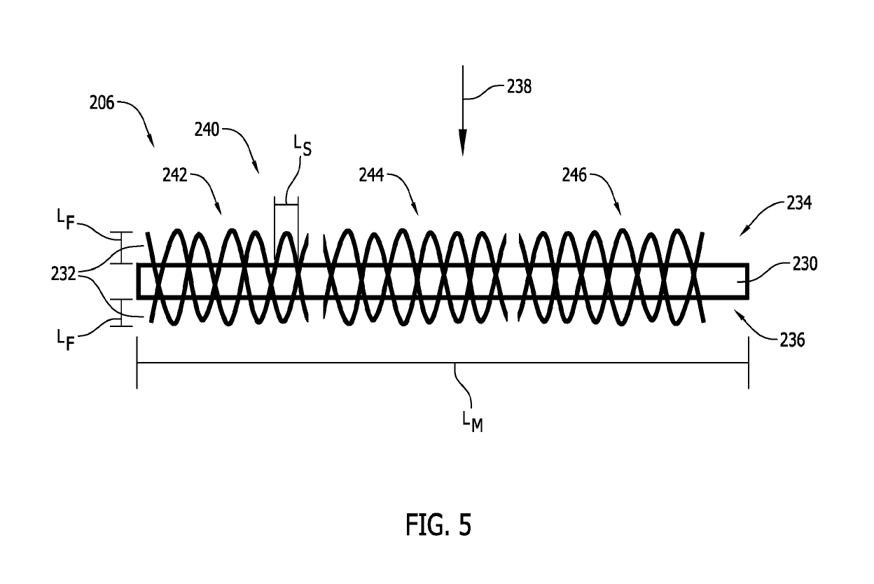

FIGS. 5-8 are illustrations of filter media 206 including fibers 232 having different stitch configurations. In the exemplary embodiments, porous membrane material 230 includes a first side 234 and an opposing second side 236. Fibers 232 are stitched into porous membrane material 230 such that at least a portion of fibers 232 protrude from first and second sides 234 and 236. Moreover, fibers 232 are stitched into porous membrane material 230 along a length L_{M} of porous membrane material 230. In operation, fluid flow 238 is directed towards filter media 206 in a direction such that particles (not shown) entrained in fluid flow 238 are collected on first side 234 of porous membrane material 230.

Stitch configurations of fibers 232 may be selected as a function of the type of material used to form fibers 232, a linear mass density of fibers 232, a location of fibers 232 in filter media 206, and a desired property to be provided to filter media 206. Moreover, stitch configurations may be modified by adjusting a needling density of fibers 232 stitched into porous membrane material 230 at different predetermined regions of filter media 206. As used herein, “needling density” refers to a number of needle punches per unit square inch of filter media 206. In the exemplary embodiment, filter media 206 has a needling density within a range between about 10 and about 100.

The needling density of fibers 232 may be adjusted by adjusting at least one of a stitch length of fibers 232, a length that fibers 232 extend from sides 234 and 236 of porous membrane material 230, and a distance between adjacent stitches of fibers 232. Adjusting the stitch length of fibers 232 and/or adjusting the distance between adjacent stitches facilitates modifying the strength and/or a filtration characteristic of filter media 206. Adjusting the length that fibers 232 extend from sides 234 and 236 of porous membrane material 230 facilitates adjusting the directionality of fluid flow through filter media 206. As such, fibers 232 are stitched into porous membrane material 230 at any needling density that enables filter media 206 to function as described herein.

Referring to FIG. 5, fibers 232 are stitched into porous membrane material 230 in a first stitch configuration 240. In the exemplary embodiment, first stitch configuration 240 includes fibers 232 separated into a first section 242, a second section 244, and a third section 246 along length L_{M} of porous membrane material 230. Fibers 232 in each section 242, 244, and 246 have a substantially uniform stitch length L_{S}, and protrude from first and second sides 234 and 236 of porous membrane material 230 at a substantially uniform length L_{F}.

As described above, predetermined regions of filter elements 200 or 202 (shown in FIGS. 2 and 3) are subjected to greater strain than other regions of filter elements 200 or 202 during operation thereof. In one embodiment, fibers 232 in at least one of sections 242, 244, and 246 are fabricated from a different material. Separating fibers 232 into separate sections enables different materials for fibers 232 to be used in different regions of filter elements 200 or 202. For example, in the exemplary embodiment, fibers 232 in first section 242 are fabricated from a first material, fibers 232 in second section 244 are fabricated from a second material, and fibers 232 in third section 246 are fabricated from a third material. The first material has a greater tensile strength than the second material, and the second material has a greater tensile strength than the third material. As such, fibers 232 of varying compositions may be selectively stitched into portions of porous membrane material 230 based on a known amount of strain to be induced to filter elements 200 or 202 during operation. In an alternative embodiment, fibers 232 fabricated from the same material and having different linear mass densities may be stitched into porous membrane material 230 to facilitate compensating for differences in known amounts of strain induced to filter media 206 during operation. For example, fibers 232 in first section 242 may have a greater linear mass density than fibers 232 in second and third sections 244 and 246.

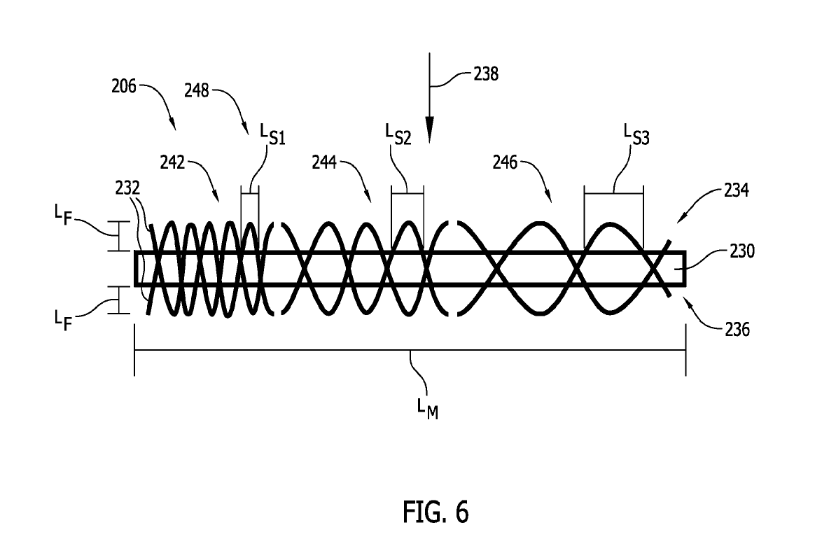

Referring to FIG. 6, fibers 232 are stitched into porous membrane material 230 in a second stitch configuration 248. In the exemplary embodiment, second stitch configuration 248 includes fibers 232 separated into first section 242, second section 244, and third section 246 along length L_{M} of porous membrane material 230. Fibers 232 protrude from first and second sides 234 and 236 of porous membrane material 230 at a substantially uniform length L_{F}.

As described above, a property of filter media 206 may be modified based on a stitch length of fibers 232 in filter media 206. In the exemplary embodiment, fibers 232 in first section 242 have a first stitch length L_{S1}, fibers 232 in second section 244 have a second stitch length L_{S2}, and fibers 232 in third section 246 have a third stitch length L_{S3}. As such, the permeability and/or porosity of filter media 206 is greater at third section 246 than at second section 244, and greater at second section 244 than at first section 242.

Moreover, in one embodiment, fibers 232 in first, second, and third sections 242, 244, and 246 are fabricated from the same material. Accordingly, the strength of filter media 206 varies between first, second, and third sections 242, 244, and 246. As such, the materials used to fabricate fibers 232 in first, second, and third sections 242, 244, and 246 may be selected based on a known amount of strain to be induced to filter media 206 during operation. Alternatively, the linear mass density of fibers 232 and/or the material used to form fibers 232 stitched into first, second, and third sections 242, 244, and 246 may be selected such that increasing the stitch length of fibers 232 does not adversely affect the strength of filter media 206.

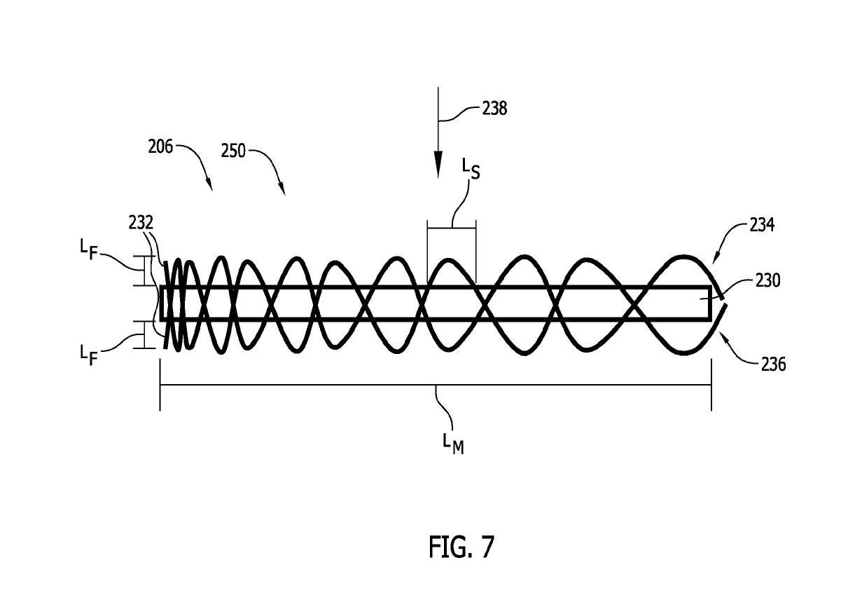

Referring to FIG. 7, fibers 232 are stitched into porous membrane material 230 in a third stitch configuration 250. In the exemplary embodiment, third stitch configuration 250 includes fibers 232 stitched into porous membrane material 230 at a progressively increasing stitch length L_{S} along length L_{M} of porous membrane material 230. Fibers 232 also protrude from first and second sides 234 and 236 of porous membrane material 230 at a substantially uniform length L_{F}. As such, the permeability and/or porosity of filter media 206 increases and the strength decreases as the stitch length increases along length L_{M} of porous membrane material 230.

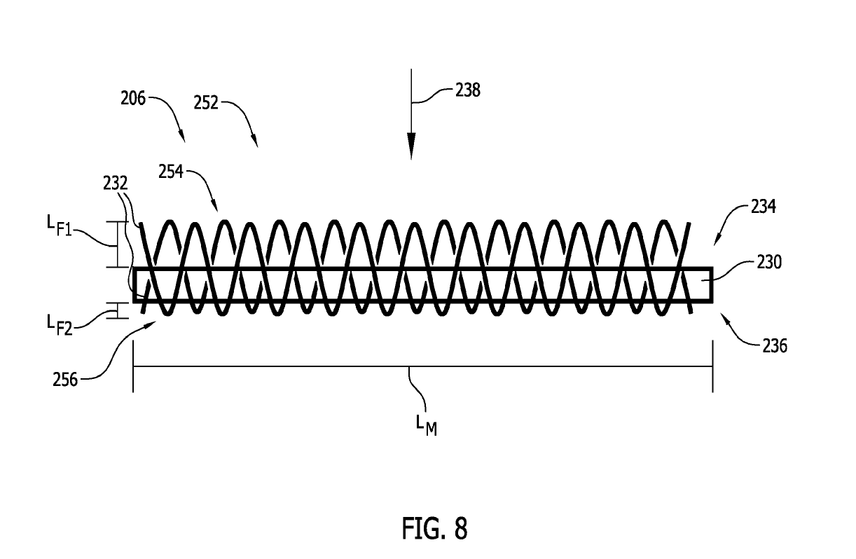

Referring to FIG. 8, fibers 232 are stitched into porous membrane material 230 in a fourth stitch configuration 252. In the exemplary embodiment, fourth stitch configuration 252 includes fibers 232 stitched into porous membrane material 230 such that fibers 232 extend from first and second sides 234 and 236 of porous membrane material 230 at different lengths. More specifically, fibers 232 are stitched such that a first portion 254 of fibers 232 extend from first side 234 at a first length L_{F1}, and such that a second portion 256 of fibers 232 extend from second side 236 at a second length L_{F2}. First length L_{F1} is greater than second length L_{F2} such that a greater volume of fibers 232 are exposed on first side 234 than on second side 236. As such, first portion 254 of fibers 232 facilitates restricting penetration of particles (not shown) entrained in fluid flow 238 through filter media 206, and enables the particles to be more easily removed from filter media 206 during cleaning operations.

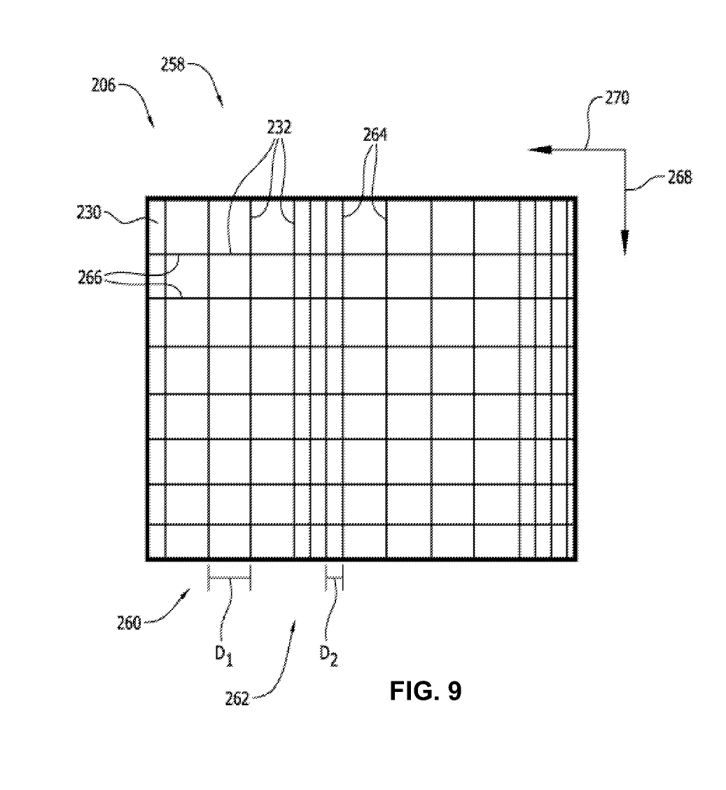

Referring to FIG. 9, fibers 232 are stitched into porous membrane material 230 in a fifth stitch configuration 258. In the exemplary embodiment, fifth stitch configuration 258 includes fibers 232 stitched into porous membrane material 230 such that a distance between adjacent stitches is adjustable based on a desired property to be provided to predetermined regions of filter media 206. More specifically, a first distance D₁ is defined between adjacent stitches in a first region 260 of filter media 206, and a second distance D₂ is defined between adjacent stitches in a second region 262 of filter media 206. First distance D₁ is greater than second distance D₂. As such, the permeability and/or porosity of filter media 206 is greater at first region 260 than at second region 262.

In some embodiments, filter media 206 may be formed with strength directionality to compensate for known amounts of strain to be induced to filter media 206 during operation. For example, in the exemplary embodiments, fibers 232 include first fibers 264 extending along porous membrane material 230 in a first direction 268, and second fibers 266 extending along porous membrane material 230 in a second direction 270 transversely to first direction 268. First fibers 264 are fabricated from material having a greater tensile strength than second fibers 266 such that filter media 206 has greater strength in first direction 268 than in second direction 270. As such, the directionality of first and second fibers 264 and 266 is selected to enable filter media 206 to have increased strength in a direction that compensates for directional strain induced to filter media 206. In an alternative embodiment, first fibers 264 may have a greater linear mass density than second fibers 266 to facilitate increasing the directional strength of filter media 206.

Fibers 232 may be stitched into porous membrane material 230 in any stitch pattern that enables filter media 206 to function as described herein. In the exemplary embodiment, fibers 232 have a substantially linear stitch pattern. In an alternative embodiment, fibers 232 may have a stitch pattern such as, but not limited to, a sinusoidal pattern and a serpentine pattern.

The filter media described herein is fabricated from materials that enable properties to be selectively provided to predetermined regions of the filter media. More specifically, the filter media is fabricated from a porous membrane material and fibers stitched into the porous membrane material in a variety of stitch configurations. Any combination of stitch configurations may be used such that the filter media has desired properties. For example, the fibers facilitate providing strength to the filter media and/or facilitate modifying a filtration characteristic of the filter media. Moreover, the fibers may be selectively stitched into the porous membrane material such that predetermined regions of the filter media have properties that are different than other regions of the filter media. As such, desired properties may be selectively provided by the fibers based on known operating conditions of the filter media. Further, the filter media described herein has a lower basis weight than known composite filter media that include nonwoven felt material coupled to a porous membrane.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A filter media comprising:
a porous membrane material; and
at least one fiber stitched into said porous membrane material, wherein a property of the filter media is selected as a function of a stitch configuration of said at least one fiber in the filter media.

2. The filter media in accordance with claim 1, wherein the property of the filter media is configured to be modified at different predetermined regions of said porous membrane material.

3. The filter media in accordance with claim 1, wherein the property of the filter media includes at least one of strength, a filtration characteristic, and an operational status of the filter media.

4. The filter media in accordance with claim 1, wherein the stitch configuration is selected as a function of at least one of material used to form said at least one fiber, a linear mass density of said at least one fiber, and a location of said at least one fiber in the filter media.

5. The filter media in accordance with claim 1, wherein a stitch length of said at least one fiber is adjustable to modify the stitch configuration of said at least one fiber.

6. The filter media in accordance with claim 1, wherein a length that said at least one fiber extends at from opposing sides of said porous membrane material is adjustable to modify the stitch configuration of said at least one fiber.

7. The filter media in accordance with claim 1 further comprising a plurality of fibers stitched into said porous membrane material, wherein a distance between adjacent stitches of said plurality of fibers is adjustable to modify the stitch configuration of said at least one fiber.

8. The filter media in accordance with claim 1, wherein said at least one fiber comprises:
a first fiber fabricated from a first material; and
a second fiber fabricated from a second material, wherein a direction that said first fibers and said second fibers extend along said porous membrane material is determined based on directional strain induced to the filter media.

9. A filtration system comprising:
a filter house; and
a filter media positioned within said filter house that comprises:
a porous membrane material; and
at least one fiber stitched into said porous membrane material, wherein a property of said filter media is selected as a function of a stitch configuration of said at least one fiber in said filter media.

10. The filtration system in accordance with claim 9, wherein the property of said filter media is selected as a function of a needling density of said at least one fiber stitched into said porous membrane material.

11. The filtration system in accordance with claim 9, wherein said at least one fiber is stitched into said porous membrane material at a needling density within a range between about 10 needles per square inch and about 100 needles per square inch.

12. The filtration system in accordance with claim 9, wherein said filter media has a basis weight of between about 8 ounces per square yard and about 10 ounces per square yard.

13. The filtration system in accordance with claim 9, wherein said at least one fiber is fabricated from at least one of a polypropylene material, a polyester material, a polyphenylene sulfide material, a polytetrafluoroethylene material, a nylon material, an aramid material, a polyarylene sulfide material, a polyimide material, a polyamide material, a polyetherimide material, and a polyamideimide material.

14. The filtration system in accordance with claim 9, wherein said at least one fiber is fabricated from a taggant material configured to provide an operational status of said filter media.

15. The filtration system in accordance with claim 9, wherein said porous membrane material is fabricated from at least one of polytetrafluoroethylene, polyvinylidene fluoride, polyalkene, polyarylene, polyamide, polyester, polysulfone, polyether, polyacrylic, polystyrene, polyurethane, polyarylate, polyimide, polycarbonate, polysiloxane, polyphenylene oxide, and cellulosic polymer.

16. A method of forming a filter media, said method comprising:
providing a porous membrane material; and
stitching at least one fiber into the porous membrane material, wherein a property of the filter media is selected as a function of a stitch configuration of the at least one fiber in the filter media.

17. The method in accordance with claim 16, wherein stitching at least one fiber comprises modifying the stitch configuration at different predetermined regions of the porous membrane material.

18. The method in accordance with claim 17, wherein modifying the stitch configuration comprises adjusting a needling density of the at least one fiber at the different predetermined regions of the porous membrane material.

19. The method in accordance with claim 16, wherein stitching at least one fiber comprises selecting the stitch configuration as a function of at least one of material used to form the at least one fiber, a linear mass density of the at least one fiber, and a location of the at least one fiber in the filter media.

20. The method in accordance with claim 16 further comprising laminating the filter media to a second porous membrane material.
